(19) United States
(12) Patent Application Publication
(10) Pub. No.: US 2010/0044235 A1
(43) Pub. Date: Feb. 25, 2010

(54) COATING COMPOSITIONS EXHIBITING CORROSION RESISTANCE PROPERTIES, RELATED COATED ARTICLES AND METHODS

(75) Inventors: Matthew S. Scott, Pittsburgh, PA (US); Richard F. Syput, Lower Burrell, PA (US); Steven R. Zawacky, Pittsburgh, PA (US)

Correspondence Address: PPG INDUSTRIES INC;INTELLECTUAL PROPERTY DEPT, ONE PPG PLACE, PITTSBURGH, PA, 15272, US

(73) Assignee: PPG Industries Ohio, Inc., Cleveland, OH (US)

(21) Appl. No.: 12/604,783

(22) Filed: Oct. 23, 2009

Related U.S. Application Data
(62) Division of application No. 11/415,582, filed on May 2, 2006.

(51) Int. Cl. B32B 15/04

(52) U.S. Cl. 205/50

(57) ABSTRACT

Disclosed are coating compositions, such as primer compositions, suitable for providing corrosion protection to metal substrates, as well as related coated articles and methods.

### FIELD OF THE INVENTION

The present invention relates to coating compositions, such as primer compositions, suitable for providing corrosion protection to metal substrates, as well as related coated articles and methods.

### BACKGROUND INFORMATION

Protection of metals from oxidation (rusting) and subsequent corrosion is often vitally important, such as, for example, when such metals are used to construct components incorporated into automotive, aerospace, architectural, and other industrial structures and parts. Various methods have been employed to achieve varying levels of corrosion protection.

In some cases, a galvanization process is used to impart corrosion protection to metallic surfaces. This process involves the hot-dip or electroplating application onto a metal substrate of a metal film deposited from a metal ingot. The metal of the metal film should have a greater ionization tendency than the metal of the metal substrate. As a result, as long as physical contact is maintained between the metal film and the substrate, the film is theoretically preferentially oxidized while the underlying substrate, which acts as an electrical conductor to transfer electrons from the metal film to oxygen, is protected.

Galvanization, however, is not ideal in all situations. For example, when utilizing hot dip galvanizing, it is difficult, if not impossible, to control the thickness of the metal film. As a result, hot dip galvanizing is not usually suitable in cases where corrosion protection is required for relatively small metal articles with complex shapes, such as fasteners, for example, nuts, bolts, and the like. Electroplating galvanization, on the other hand, while often enabling improved film thickness control over hot dip galvanizing, can be an expensive process due, for example, for the need to prevent “hydrogen embrittlement.” This phenomena is known to occur during the plating process, wherein hydrogen is absorbed into the coated metal article and entrapped. Subsequently, the hydrogen can cause failure. As a result, additional, costly process steps are often employed to minimize or prevent hydrogen embrittlement.

In some cases, metal substrates are protected by use of corrosion-resisting primer coatings that incorporate metal particles, often zinc, as a metallic pigment. These coating compositions produce a coating that utilizes the same mechanism for corrosion protection as the metal films resulting from galvanizing. Often referred to as “zinc-rich primers”, such coating compositions often outperform galvanization and are commonly applied to a metal substrate by a dip spin procedure. These compositions often incorporate zinc particles, often zinc flake, as the metallic pigment in combination with an organic binder, such as an epoxy resin and/or an inorganic binder, such as a silicate.

While “zinc-rich primers” developed heretofore are suitable in many applications, they do have certain drawbacks that can render them deficient in some cases. For example, to be effective, it is believed that these compositions should deposit a continuous layer of metallic pigment, such as zinc, onto the metal substrate. When a powder, which is relatively inexpensive, is used, it is often important to apply the composition at relatively large film thickness, usually greater than 3 mils (76.2 microns), to ensure that a continuous layer of metallic pigment is deposited. The use of such thick films is, of course, undesirable from a cost standpoint. It can also render the use of such compositions impractical when corrosion protection is required for relatively small metal articles with complex shapes, such as fasteners, for example, nuts, bolts, and the like.

As a result of this perceived deficiency, metal flakes, such as zinc flakes, are often used as the metallic pigment in zinc-rich primer compositions. The use of these thin, plate-like structures, can result in the deposition of a continuous film of metallic pigment, even when the composition is deposited at a relatively low film thickness, even below 1 mil (25.4 microns). The nature of these materials, however, often causes the resultant coating to exhibit poor adhesion to a metal substrate as well as subsequently applied coatings. Thus, up to four dip applications of a solvent based colored coating composition is often applied over the primer (black is often a desired color). Moreover, aqueous based, electrodepositable coating compositions, which are often desirable for use as corrosion inhibiting coating compositions, often do not adhere to zinc-rich primers that rely on the use of zinc flakes.

A disadvantage that has been observed in the use of inorganic binders in zinc-rich primer compositions is that they tend to be brittle and, therefore, the resulting zinc-rich primer composition can be powdery and exhibit poor adhesion to the metal substrate. This deficiency is particularly problematic when attempting to coat small parts, such as fasteners, which are handled in bulk. In this process, the parts often contact one another. As a result, when a brittle, poorly adhered film is applied to the parts, the film is easily damaged when the parts contact one another during the coating process. This damage leads to poor corrosion resistance performance.

As a result, it would be desirable to provide coating compositions that can impart desirable levels of corrosion protection to metal substrates even when applied at relatively low film thickness. Moreover, it would be desirable to provide such coating compositions that are flexible and adhere well to metal substrates as well as a subsequently applied aqueous electrodepositable coating composition, to provide a desired color and a desirable level of corrosion protection to a metal article, such as small metal parts with complex shapes, such as fasteners, for example, nuts, bolts, and the like.

### SUMMARY OF THE INVENTION

In certain respects, the present invention is directed to coating compositions comprising: (a) metal particles; and (b) a film-forming binder comprising a hybrid organic-inorganic copolymer formed from: (i) a titanate and/or a partial hydrolysate thereof; and (ii) a polyfunctional polymer having functional groups reactive with alkoxy groups of the titanate and/or the partial hydrolysate thereof.

In other respects, the present invention is directed to coating compositions comprising: (a) metal particles; and (b) a film-forming binder comprising a structure represented by the general formula:

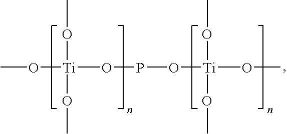

wherein P is the residue of a polyfunctional polymer, and each n is an integer having a value of 1 or more and may be the same or different.

In still other respects, the present invention is directed to zinc-rich primer compositions comprising: (a) zinc particles which are present in an amount of at least 70 percent by weight, based on the total weight of the composition; and (b) a binder formed from a titanate.

In yet other respects, the present invention is directed to metal articles at least partially coated with a multi-component composite coating comprising: (a) a zinc-rich primer coating; and (b) an electrodeposited coating deposited over at least a portion of the zinc-rich primer coating. These articles of the present invention are resistant to corrosion after 500 hours of exposure, when the total combined dry film thickness of the zinc-rich primer and the electrodeposited coating is no more than 1.5 mils (38.1 microns).

In other respects, the present invention is directed to metal articles at least partially coated with a multi-component composite coating comprising: (a) a zinc-rich primer coating; and (b) an electrodeposited coating deposited over at least a portion of the zinc-rich primer coating, wherein the total combined dry film thickness of the zinc-rich primer and the electrodeposited coating is no more than 1.5 mils (38.1 microns) and wherein the articles are resistant to corrosion after 500 hours of exposure.

The present invention is directed to methods for providing metal articles that comprise a surface that is resistant to corrosion after 500 hours of exposure, the method comprising: (a) depositing a zinc-rich primer coating over at least a portion of the surface, wherein the zinc-rich primer coating is deposited from a composition comprising: (i) zinc particles present in the composition in an amount of at least 50 percent by weight, based on the total weight of the composition, and (ii) a binder formed from a titanate; and (b) electrodepositing a coating over at least a portion of the zinc-rich primer coating, wherein the total combined dry film thickness of the zinc-rich primer and the electrodeposited coating is no more than 1.5 mils (38.1 microns).

### DETAILED DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

As previously mentioned, certain embodiments of the present invention are directed to coating compositions that comprise metal particles. The metal particles incorporated into the coating compositions of the present invention are selected to have a greater ionization tendency than that of the metal substrate to which the composition is to be applied. Thus, as is often the case, when the metal substrate is iron or an iron alloy, such as steel, the metal particles will typically comprise zinc particles, aluminum particles, zinc-aluminum alloy particles, or a mixture thereof. In some cases, the purity of the metal particles is at least 94% by weight, such as at least 95% by weight.

In certain embodiments, the coating compositions of the present invention are zinc-rich primer compositions. As used herein, the term “zinc-rich primer composition” refers to compositions comprising zinc particles, such as zinc powder, zinc dust, and/or zinc flake, which are present in the composition in an amount of at least 50 percent by weight, in many cases at least 70 percent by weight, such as 70 to 95 percent by weight, or, in some cases, 85 to 95 percent by weight, with the weight percents being based on the total weight of solids in the composition, i.e., the dry weight of the composition.

The particle size of the metal particles, such as zinc particles, can vary. In addition, the shape (or morphology) of the particles, such as zinc particles, can vary. For example, generally spherical morphologies can be used, as well as particles that are cubic, platy, or acicular (elongated or fibrous). In some cases, the metal particles comprise “metal powder”, which, as used herein, refers to generally spherical particles having an average particle size of no more than 20 microns, such as 2 to 16 microns. In some cases, the metal particles comprise “metal dust”, which, as used herein, refers to metal powder, such as zinc powder, having an average particle size of 2 to 10 microns. In some cases, metal particles comprise metal flakes, such as zinc flakes, which, as used herein, refers to particles having a different aspect ratio than powder or dust (i.e., not a generally spherical structure) and having an elongated dimension of up to 100 microns. In some cases, mixtures of metal powder, dust, and/or flakes are used.

In certain embodiments, the metal particles utilized in the coating compositions of the present invention comprise zinc powder and/or zinc dust. In certain embodiments, zinc powder is present in an amount of at least 25 percent by weight, such as at least 50 percent by weight, in some cases at least 80 percent by weight, and, in yet other cases, at least 90 percent by weight, based on the total weight of the metal particles in the coating composition.

Moreover, in certain embodiments, the coating compositions of the present invention are substantially free or, in some cases, completely free of zinc flakes. As used herein, the term “substantially free” means that the material being discussed is present, if at all, as an incidental impurity. In other words, the material does not effect the properties of another substance. As used herein, the term “completely free” means that the material is not present in another substance at all.

In certain embodiments, however, the coating compositions of the present invention comprise metal flakes comprising zinc alloy particles, such as zinc/aluminum and/or zinc/tin alloys, among others. Such materials, which are suitable for use in the present invention, are described in United States Published Patent Application No. 2004/0206266 at [0034] to [0036], the cited portion of which being incorporated herein by reference. Indeed, the inventors have surprisingly discovered that the addition of zinc-tin alloy particles in relatively small amounts, i.e., no more than 10 percent by weight, based on the total weight of solids in the composition, can result in significant improvement in the corrosion-resisting properties of certain coating compositions described herein. Such materials are commercially available from, for example, Eckart-Werke as STAPA 4 Zn Sn 15.

The coating compositions of the present invention also comprise a film-forming binder. As used herein, the term “binder” refers to a material in which the metal particles are distributed and which serves to bond the coating composition to either a bare or previously coated substrate, such as a metal substrate. As used herein, the term “film-forming binder” refers to a binder that forms a self-supporting continuous film on at least a horizontal surface of a substrate upon removal of diluents and/or carriers that may be present in the composition.

In certain embodiments, the film-forming binder present in the coating compositions of the present invention comprises a hybrid organic-inorganic copolymer. As used herein, the term “copolymer” refers to a material created by polymerizing a mixture of two or more starting compounds. As used herein, the term “hybrid organic-inorganic copolymer” refers to a copolymer with inorganic repeating units and organic repeating units. For purposes of the present invention, the term “organic repeating units” is meant to include repeating units based on carbon and/or silicon (even though silicon is not normally considered an organic material), while the term “inorganic repeating units” is meant to refer to repeating units based on an element or elements other than carbon or silicon.

In certain embodiments, the film-forming binder utilized in certain embodiments of the coating compositions of the present invention is formed from a titanate and/or a partial hydrolysate thereof. As used herein, the term “titanate” refers to a compound comprising four alkoxy groups, which compound is represented by the formula Ti(OR)₄, wherein each R is individually a hydrocarbyl radical containing from, for example, 1 to 10, such as 1 to 8, or, in some cases 2 to 5 carbon atoms per radical, such as, for example, alkyl radicals, cycloalkyl radicals, alkylenyl radicals, aryl radicals, alkaryl radicals, aralkyl radicals, or combinations of two or more thereof, i.e., each R can be the same or different. Such materials, which are suitable for use in the present invention, are described in U.S. Pat. No. 6,562,990 at col. 4, line 63 to col. 5, line 9, the cited portion of which being incorporated herein by reference. Commercially available materials, which are examples of titanates that are suitable for use in the present invention, are the products sold by DuPont under the tradename TYZOR®, such as TYZOR TPT, which refers to tetraisopropyl titanate, TYZOR TnBT, which refers to tetra-n-butyl titanate, and TYZOR TOT, and which refers to tetra-2-ethylhexyl titanate.

In certain embodiments, the titanate used in preparing the film-forming binder utilized in certain embodiments of the coating compositions of the present invention is a chelated titanate. Suitable chelated titanates include, but are not limited to, products commercially available from DuPont under the TYZOR tradename. Suitable chelated titanates also include, but are not limited to, the chelated titanates described in U.S. Pat. Nos. 2,680,108 and 6,562,990, which are incorporated herein by reference. In certain embodiments of the present invention, a chelated titanate is used that is formed from the use of a chelating agent comprising a dicarbonyl compound. Dicarbonyl compounds that are suitable for use in preparing the titanium chelate utilized as a binder in certain embodiments of the coating compositions of the present invention include, but are not limited to, the materials described in U.S. Pat. No. 2,680,108 at col. 2, lines 13-16 and U.S. Pat. No. 6,562,990 at col. 2, lines 56-64.

In certain embodiments of the present invention, the film-forming binder is formed from the reaction of a titanate and/or a partial hydrolysate thereof, such as any of the titanates and/or chelated titanates previously described, and a polyfunctional polymer comprising functional groups reactive with alkoxy groups of the titanate and/or a partial hydrolysate thereof. As used herein, the term “polymer” is meant to include oligomers and both homopolymers and copolymers. Suitable polymers include, for example, acrylic polymers, polyester polymers, polyurethane polymers, polyether polymers and silicon-based polymers, i.e., polymers comprising one or more —SiO— units in the backbone. As used herein, the term “polyfunctional polymer” is meant to refer to polymers having at least two functional groups. As used herein, the phrase “formed from” denotes open, e.g., “comprising,” claim language. As such, a composition or substance “formed from” a list of recited components refers to a composition or substance comprising at least these recited components, and can further comprise other, non-recited components, during the composition or substance's formation.

As indicated, the polyfunctional polymer utilized in the preparation of the film-forming binder of certain embodiments of the coating compositions of the present invention comprises two or more functional groups reactive with alkoxy groups of the titanate and/or partial hydrolysate thereof. Examples of such functional groups are hydroxyl groups, thiol groups, primary amine groups, secondary amine groups, and acid (e.g. carboxylic acid) groups, as well as mixtures thereof.

In certain embodiments, the polyfunctional polymer utilized in the preparation of the film-forming binder of certain embodiments of the coating compositions of the present invention comprises a polyhydroxy compound, i.e., a polyol. As used herein, the terms “polyhydroxy compound” and “polyol” refers to materials having an average of two or more hydroxyl groups per molecule. Suitable polyols include, but are not limited to, those described in U.S. Pat. No. 4,046,729 at col. 7, line 52 to col. 10, line 35, the cited portion of which being incorporated by reference.

In certain embodiments of the present invention, the polyol is formed from reactants comprising (i) a polyol, such as a diol (a material having two hydroxyl groups per molecule), comprising an aromatic group and (ii) an alkylene oxide. In these embodiments, the aromatic group containing polyol, such as a diol, may include one or more aromatic rings, and if more than one ring is present, the rings can be fused and/or unfused. Examples of aromatic group containing diols, which are suitable for use in the present invention, are bisphenols, such as Bisphenols A, F, E, M, P and Z. In these embodiments, the polyol undergoes chain extension by reaction with an alkylene oxide. The alkylene moiety of the alkylene oxide can have any number of carbon atoms, and can be branched or unbranched. Examples of suitable, but non-limiting, alkylene oxides are those having from 1 to 10 carbon atoms, such as those having 2 to 4 carbon atoms. Such compounds are widely commercially available.

In these embodiments, the polyol can be reacted with the alkylene oxide in any suitable molar ratio. For example, the ratio of aromatic diol to the alkylene oxide can be from 1:1 to 1:10, or even higher. Standard reaction procedures can be used to react the alkylene oxide to one or more of the hydroxyl groups of the polyol, and to further link the alkylene oxide groups to each other for additional chain extension. Alternatively, suitable materials are commercially available, such as from BASF, in their MACOL line of products. One suitable product is a material in which six moles of ethylene oxide are reacted with one mole of Bisphenol A, commercially available as MACOL 98B.

As a result, as will be apparent from the foregoing description, the film-forming binder utilized in certain embodiments of the coating compositions of the present invention comprises a structure represented by the general formula:

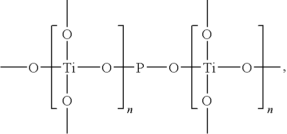

wherein P is the residue of a polyfunctional polymer, such as a polyol, such as a polyol formed from the reaction of a polyol comprising an aromatic group and an alkylene oxide; and each n is an integer having a value of 1 or more, such as 1 to 10, or, in some cases, n is 1, and each n may be the same or different. As will be appreciated, to obtain a structure as previously described wherein n is greater than 1, water may be added to the titanate to form a partial hydrolysate. This can be accomplished prior to addition of a polyfunctional polymer, with the polyfunctional polymer, or after the addition of the polyfunctional polymer. Otherwise, commercially available partial hydrolysates, such as TYZOR BTP (n-butyl polytitanate), can be used.

The Examples herein illustrate suitable methods for producing a film-forming binder utilized in certain embodiments of the coating compositions of the present invention. In certain embodiments, such a binder is produced by reacting a titanate and a polyfunctional polymer at a weight ratio of from 1 to 6, such as 3 to 5, parts by weight titanate, measured on the basis of theoretical TiO₂ content in the resulting binder, to 1 part by weight of the polyfunctional polymer. Indeed, the inventors have surprisingly discovered that use of a film-forming binder comprising the hybrid organic-inorganic copolymer formed from such a reaction can produce zinc-rich primer compositions wherein the amount of organic material is minimized, while still obtaining desirable film properties due to, it is believed, the presence of the organic repeating units. It is believed that this minimization of organic species is beneficial because such species can act as an insulator between zinc particles, thereby reducing their sacrificial activity. It is also believed that the minimization of organic species in the compositions of the present invention can render such compositions particularly suitable for use on metal parts that are intended to be utilized in relatively high temperature applications, where such organic species may degrade, such as, for example, automobile mufflers and the like.

In certain embodiments, the film-forming binder is present in the coating compositions of the present invention in an amount of 2 to 10 percent by weight, such as 3 to 7 percent by weight, with the weight percents being based on the total weight of solids in the composition, i.e., the dry weight of the composition.

The coating compositions of the present invention may include other materials, if desired. For example, in certain embodiments, the coating compositions of the present invention comprise a diluent so that the composition will have a desired viscosity for application by conventional coating techniques. Suitable diluents include, but are not limited to, alcohols, such as those having up to about 8 carbon atoms, such as ethanol and isopropanol and alkyl ethers of glycols, such as 1-methoxy-2-propanol, and monoalkyl ethers of ethylene glycol, diethylene glycol and propylene glycol; ketones, such as methyl ethyl ketone, methyl isobutyl ketone and isophorone; esters and ethers, such as 2-ethoxyethyl acetate and 2-ethoxyethanol; aromatic hydrocarbons, such as benzene, toluene, and xylene; and aromatic solvent blends derived from petroleum, such as those sold commercially under the trademark SOLVESSO®. The amount of diluent will vary depending on the method of coating, the binder component, the metal particles to binder ratio, and the presence of optional ingredients such as those mentioned below.

In addition to the ingredients described above, the coating compositions of the present invention may contain, for example, a secondary resin, a thickener, a thixotropic agent, a suspension agent, and/or a hygroscopic agent, including those materials described in U.S. Pat. No. 4,544,581 at col. 3, line 30 to col. 4, lines 64, the cited portion of which being incorporated herein by reference. Other optional materials include extenders, for example, iron oxides and iron phosphides, flow control agents, for example, urea-formaldehyde resins, and/or dehydrating agents, such as silica, lime or a sodium aluminum silicate.

In certain embodiments, other pigments may be included in the composition, such as carbon black, magnesium silicate (talc), and zinc oxide. In certain embodiments, the coating compositions of the present invention also include an organic pigment, such as, for example, azo compounds (monoazo, di-azo, β-Naphthol, Naphthol AS, azo pigment lakes, benzimidazolone, di-azo condensation, metal complex, isoindolinone, isoindoline), and polycyclic (phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone) pigments, as well as mixtures thereof.

The coating compositions of the present invention are substantially free or, in some cases, completely free, of heavy metals, such as chrome and lead. As a result, certain embodiments of the present invention are directed to “chrome-free” coating compositions, i.e., compositions that do not include chrome-containing substances.

One advantage of certain embodiments of the coating compositions of the present invention is that, unlike many prior art zinc rich primer compositions, they may be embodied as a single component, i.e., one-package, coating composition. As a result, the coating compositions of certain embodiments of the present invention can be easily prepared, stored, and transported.

The coating compositions of the present invention may be applied to a substrate by any of a variety of typical application methods, such as immersion, including dip drain and dip-spin procedures (after dipping, the article is spun in order to scatter any excess coating material by centrifugal force), curtain coating, rolling, brushing or spraying techniques.

Any article may be coated with the coating compositions of the present invention, such as, for example, those that are constructed of ceramics or plastics. In many cases, however, the article is a metal article and, as a result, the coating compositions are, in these embodiments, applied to a metal substrate, such as a zinc or iron containing substrate, e.g., a steel substrate. As used herein, the term “zinc substrate” refers to a substrate of zinc or zinc alloy, or a metal such as steel coated with zinc or zinc alloy, as well as a substrate containing zinc in intermetallic mixture. Likewise, the iron of the substrate can be in alloy or intermetallic mixture form.

In certain embodiments, the metal article to be coated with a coating composition of the present invention is a “small part”. As used herein, the term “small part” is meant to include (i) fasteners, such as nuts, bolts, screws, pins, nails, clips, and buttons, (ii) small size stampings, (iii) castings, (iv) wire goods, and (v) hardware. In certain embodiments, the small part is a fastener to be used in an automotive and/or aerospace application.

In certain embodiments, such metal substrates comprise a bare uncoated or untreated surface. In other cases, however, the coating compositions of the present invention are applied to a metal substrate that has already been coated, such as with a chromate or phosphate pretreatment. In some cases, the substrate may be pretreated to have, for example, an iron phosphate coating in an amount from 50 to 100 mg/ft² or a zinc phosphate coating in an amount from 200 to 2,000 mg/ft².

The coating compositions of the present invention may be deposited onto the substrate at any desired film thickness. In many cases, however, relatively thin films, i.e., dry film thickness of no more than 0.5 mils (12.7 microns), in some cases no more than 0.2 mils (5.1 microns), are desirable. For purposes of the present invention, the dry film thickness of a coating or combination of coatings is to be measured by the eddy-current principle (ASTM B244) using, for example a FISHERSCOPE® MMS thicknessmeter, manufactured by Fisher Instruments, using the appropriate probe for the material of the coated substrate.

In certain embodiments, another coating is deposited over at least a portion of the coating composition of the present invention. In particular, in certain embodiments of the present invention, an electrodepositable coating composition is deposited over at least a portion of the previously described coating composition by an electrodeposition process.

Any suitable electrodeposition process and electrodepositable coating composition may be used in accordance with the present invention. As will be appreciated by those skilled in the art, in the process of applying an electrodepositable coating composition, an aqueous dispersion of the composition is placed in contact with an electrically conductive anode and cathode. Upon passage of an electric current between the anode and cathode, an adherent film of the electrodepositable composition deposits in a substantially continuous manner on the substrate serving as either the anode or the cathode depending on whether the composition is anionically or cationically electrodepositable.

In certain embodiments, the electrodepositable coating composition comprises a resinous phase dispersed in an aqueous medium. The resinous phase includes a film-forming organic component which can comprise an anionic film-forming organic component or a cationic film-forming organic component. In certain embodiments, the electrodepositable coating composition comprises an active hydrogen group-containing ionic resin and a curing agent having functional groups reactive with the active hydrogens of the ionic resin.

Non-limiting examples of anionic electrodepositable coating compositions include those comprising an ungelled, water-dispersible electrodepositable anionic film-forming resin. Examples of film-forming resins suitable for use in anionic electrodeposition coating compositions are base-solubilized, carboxylic acid containing polymers, such as the reaction product or adduct of a drying oil or semi-drying fatty acid ester with a dicarboxylic acid or anhydride; and the reaction product of a fatty acid ester, unsaturated acid or anhydride and any additional unsaturated modifying materials which are further reacted with polyol. Also suitable are the at least partially neutralized interpolymers of hydroxy-alkyl esters of unsaturated carboxylic acids, unsaturated carboxylic acid and at least one other ethylenically unsaturated monomer. Yet another suitable electrodepositable anionic resin comprises an alkyd-aminoplast vehicle, i.e., a vehicle containing an alkyd resin and an amine-aldehyde resin. Yet another anionic electrodepositable resin composition comprises mixed esters of a resinous polyol. These compositions are described in detail in U.S. Pat. No. 3,749,657 at col. 9, line 1 to col. 10, line 13, the cited portion of which being incorporated herein by reference.

By “ungelled” is meant that the polymer is substantially free of crosslinking and has an intrinsic viscosity when dissolved in a suitable solvent. The intrinsic viscosity of a polymer is an indication of its molecular weight. A gelled polymer, since it is of essentially infinitely high molecular weight, will have an intrinsic viscosity too high to measure.

A wide variety of cationic polymers are known and can be used in the present invention so long as the polymers are “water dispersible,” i.e., adapted to be solubilized, dispersed, or emulsified in water. The water dispersible resin is cationic in nature, that is, the polymer contains cationic functional groups to impart a positive charge. Often, the cationic resin also contains active hydrogen groups.

Non-limiting examples of suitable cationic resins are onium salt group-containing resins, such as ternary sulfonium salt group-containing resins and quaternary phosphonium salt-group containing resins, for example, those described in U.S. Pat. Nos. 3,793,278 and 3,984,922, respectively. Other suitable onium salt group-containing resins include quaternary ammonium salt group-containing resins, for example, those that are formed from reacting an organic polyepoxide with a tertiary amine salt, as described in U.S. Pat. Nos. 3,962,165; 3,975,346; and 4,001,101. Also suitable are amine salt group-containing resins, such as the acid-solubilized reaction products of polyepoxides and primary or secondary amines such as those described in U.S. Pat. Nos. 3,663,389; 3,984,299; 3,947,338 and 3,947,339.

In certain embodiments, the above-described salt group-containing resins are used in combination with a blocked isocyanate curing agent. The isocyanate can be fully blocked, as described in U.S. Pat. No. 3,984,299, or the isocyanate can be partially blocked and reacted with the resin backbone, such as is described in U.S. Pat. No. 3,947,338.

Also, one-component compositions as described in U.S. Pat. No. 4,134,866 and DE-OS No. 2,707,405 can be used as the cationic resin. Besides the epoxy-amine reaction products, resins can also be selected from cationic acrylic resins such as those described in U.S. Pat. Nos. 3,455,806 and 3,928,157. Also, cationic resins which cure via transesterification, such as described in European Application No. 12463, can be used. Further, cationic compositions prepared from Mannich bases, such as described in U.S. Pat. No. 4,134,932, can be used. Also useful are positively charged resins that contain primary and/or secondary amine groups, such as is described in U.S. Pat. Nos. 3,663,389; 3,947,339; and 4,115,900.

In certain embodiments, the cationic resin is present in the electrodepositable coating composition in amounts of 1 to 60 weight percent, such as 5 to 25 weight percent, with the weight percents being based on total weight of the composition.

As previously discussed, the electrodepositable coating compositions which are useful in the present invention often further comprise a curing agent which contains functional groups which are reactive with the active hydrogen groups of the ionic resin. Suitable aminoplast resins, which are often used as curing agents for anionic electrodepositable coating compositions, are commercially available from American Cyanamid Co. under the trademark CYMEL® and from Monsanto Chemical Co. under the trademark RESIMENE®. In certain embodiments, the aminoplast curing agent is utilized in conjunction with the active hydrogen containing anionic electrodepositable resin in amounts ranging from 5 to 60 percent by weight, such as 20 to 40 percent by weight, based on the total weight of the resin solids in the electrodepositable coating composition.

Blocked organic polyisocyanates are often used as curing agents for cationic electrodepositable coating compositions and may be fully blocked or partially blocked, as described above. Specific examples include aromatic and aliphatic polyisocyanates, including cycloaliphatic polyisocyanates, such as diphenylmethane-4,4′-diisocyanate (MDI), 2,4- or 2,6-toluene diisocyanate (TDI), including mixtures thereof, p-phenylene diisocyanate, tetramethylene and hexamethylene diisocyanates, dicyclohexylmethane-4,4′-diisocyanate, isophorone diisocyanate, mixtures of phenylmethane-4,4′-diisocyanate and polymethylene polyphenylisocyanate, as well as higher polyisocyanates, such as triisocyanates, and isocyanate prepolymers with polyols such as neopentyl glycol and trimethylolpropane and with polymeric polyols such as polycaprolactone diols and triols (NCO/OH equivalent ratio greater than 1). The polyisocyanate curing agents are often utilized in conjunction with the cationic resin in amounts ranging from 1 to 65 percent by weight, such as 5 to 45 percent by weight, based on the weight of the total resin solids in the coating composition.

The electrodepositable coating compositions utilized in the present invention are typically in the form of an aqueous dispersion. The term “dispersion” refers to a two-phase transcoating, translucent or opaque resinous system in which the resin is in the dispersed phase and the water is in the continuous phase. The resinous phase generally has an average particle size of less than 1 micron, such as less than 0.5 microns, or, in some cases, less than 0.15 micron.

In certain embodiments, the concentration of the resinous phase in the aqueous medium is at least 1 percent by weight, such as 2 to 60 percent by weight, based on the total weight of the aqueous dispersion. When such compositions are in the form of resin concentrates, they often have a resin solids content of 20 to 60 percent by weight, based on weight of the aqueous dispersion.

In addition, the aqueous medium may contain a coalescing solvent. Useful coalescing solvents include hydrocarbons, alcohols, esters, ethers and ketones. The amount of coalescing solvent, if any, is generally between 0.01 and 25 percent, such as 0.05 to 5 percent by weight, based on total weight of the aqueous medium.

A pigment composition and, if desired, various additives, such as surfactants, wetting agents or catalysts can be included in the dispersion. The pigment composition may be of the conventional type comprising pigments, for example, iron oxides, strontium chromate, carbon black, coal dust, titanium dioxide, talc, barium sulfate, as well as color pigments such as cadmium yellow, cadmium red, chromium yellow and the like.

The pigment content of the dispersion is usually expressed as a pigment-to-resin ratio. In certain embodiments, when pigment is employed, the pigment-to-resin ratio is usually within the range of 0.02 to 1:1. The other additives mentioned above are often in the dispersion in amounts of 0.01 to 3 percent by weight based on weight of resin solids in the composition.

In certain embodiments of the present invention, the electrodepositable coating composition is deposited onto the substrate so as to result in a relatively thin film, i.e., a dry film thickness of no more than 0.5 mils (12.7 microns), in some cases no more than 0.2 mils (5.1 microns). Such compositions may be applied to the metal substrate using any suitable apparatus, such as, for example, one of the methods and/or apparatus described in one or more of United States Published Patent Application Nos. 2006/0032751A1; 2006/0032748A1; 2006/0049062A1; 2006/0051512A1, and 2006/0051511A1.

The inventors have surprisingly discovered that it is possible to produce metal articles coated with a multi-component composite coating comprising (i) a zinc-rich primer coating and (ii) an electrodeposited coating deposited over at least a portion of the zinc-rich primer coating, which can exhibit excellent adhesion and corrosion resistance properties, even when relatively low film thicknesses are used. As used herein, the term “zinc-rich primer coating” refers to a coating deposited from a zinc-rich primer composition. As used herein, the term “electrodeposited coating” refers to a coating deposited, by an electrodeposition process, from an aqueous electrodepositable composition. As used herein, when it is stated that a coating is “deposited over” another coating, it is meant encompass scenarios where the coating is applied directly to the other coating, with no intervening coating layers being present, as well as situations where an intervening coating layer separates the two coatings. In certain embodiments of the present invention, however, the electrodeposited coating is deposited directly over at least a portion of the zinc-rich primer, with no intervening coating layers being present.

In certain embodiments, therefore, the present invention is directed to metal articles at least partially coated with a multi-component composite coating comprising: (a) a zinc-rich primer coating; and (b) an electrodeposited coating deposited over at least a portion of the zinc-rich primer coating, wherein the article is resistant to corrosion when tested in accordance with ASTM B117 after 500 hours of exposure, in some cases after 700 hours of exposure, or, in yet other cases, after 1000 hours of exposure, when the total combined dry film thickness of the zinc-rich primer and the electrodeposited coating is 1.5 mils or less (38.1 microns), in some cases 1 mil (25.4 microns) or less. As used herein, when it is stated that an article is “resistant to corrosion” it means that the portion of the article coated with the multi-component composite coating has no red rust visible to the naked eye after exposure in accordance with ASTM B117 for a specified period of time, wherein the article is placed in a chamber kept at constant temperature where it is exposed to a fine spray (fog) of a 5 percent salt solution, rinsed with water and dried. Furthermore, when it is stated in this application that an article is resistant to corrosion “after 500 hours of exposure” it is meant that the article is resistant to corrosion when so tested for 500 hours exactly as well as articles resistant to corrosion when so tested after a selected number of hours greater than 500 hours, such as a selected number of hours between 500 and 1000 hours. Likewise, when it is stated in this application that an article is resistant to corrosion “after 700 hours of exposure” or “after 1000 hours of exposure” it is meant that the article is resistant to corrosion when so tested for 700 hours or 1000 hours exactly as well as articles resistant to corrosion when so tested after a selected number of hours greater than 700 hours or 1000 hours.

The present inventors have also found that such multi-component composite coatings adhere to each other and to metal substrates. Adhesion, for purposes of the present invention, is measured using a Crosshatch adhesion test wherein, using a multi-blade cutter (commercially available from Paul N. Gardner Co., Inc.), a coated substrate is scribed twice (at 90° angle), making sure the blades cut through all coating layers into the substrate. Coating adhesion is measured using Nichiban L-24 tape (four pulls at 90°). Four purposes of the present invention, a coating is considered to “adhere to a metal substrate” if at least 80%, in some cases, 90% or more, of the coating adheres to the substrate after this test.

As will be appreciated, the coated articles described herein may also include a decorative and/or protective topcoating applied over the zinc-rich primer or the multi-component composite coatings previously described. Such topcoatings may be deposited from any composition of the type conventionally used in automotive OEM compositions, automotive refinish compositions, industrial coatings, architectural coatings, electrocoatings, powder coatings, coil coatings, and aerospace coatings applications. Such compositions typically include film-forming resins, such as, for example, the materials described in U.S. Pat. No. 6,913,830 at col. 3, line 15 to col. 5, line 8, the cited portion of which being incorporated herein by reference. Such coating compositions may be applied using any conventional coating technique and utilizing conditions that will be easily determinable by those skilled in the art.

The present invention is also directed to methods for providing metal articles that comprise a surface that is resistant to corrosion when tested in accordance with ASTM B117 after 500 hours of exposure. These methods comprise: (a) depositing a zinc-rich primer coating over at least a portion of the surface, wherein the zinc-rich primer coating is deposited from a zinc-rich primer composition comprising: (i) zinc powder present in the composition in an amount of at least 50 percent by weight, based on the total weight of the composition, and (ii) a binder formed from a titanate; and (b) electrodepositing a coating over at least a portion of the zinc-rich primer coating, wherein the total combined dry film thickness of the zinc-rich primer and the electrodeposited coating is no more than 1.5 mils (38.1 microns).

As should also be apparent from the foregoing description, the present invention is also directed to metal articles at least partially coated with a multi-component composite coating comprising: (a) a zinc-rich primer coating; and (b) an electrodeposited coating deposited over at least a portion of the zinc-rich primer coating, wherein the total combined dry film thickness of the zinc-rich primer and the electrodeposited coating is no more than 1.5 mils (38.1 microns) and the articles are resistant to corrosion when tested in accordance with ASTM B117 after 500 hours of exposure.

Illustrating the invention are the following examples that are not to be considered as limiting the invention to their details. All parts and percentages in the examples, as well as throughout the specification, are by weight unless otherwise indicated.

### EXAMPLES

### Example 1

Charge 2 and 3 from Table 1 were premixed together then added with agitation over a 5 minute period into Charge 1 in a round bottom flask fitted with an agitation blade, a condenser, a distillate trap, and continuous nitrogen feed. After 30 minutes the temperature was raised until distillation occurred. After 24 grams of distillate was removed, Charge 4 was added. The resulting material was amber in color and was pourable at room temperature.

TABLE 1

| Charge # | Material | Amount (grams) |
|---|---|---|
| 1 | Tyzor ® TnBT¹ | 200 |
| 2 | Deionized Water | 7.1 |
| 3 | MACOL ® 98B² | 94.6 |
| 4 | Solvent Blend | 24 |
| | 24% benzyl alcohol | |
| | 23% toluene | |
| | 24% MIBK | |
| | 24% SOLVESSO ® 100³ | |
| | 5% n-butanol | |

¹Tetra-n-butyl titanate commercially available from E.I. duPont de Nemours and Co.
²Bis-phenol A-ethylene oxide diol commercially available from BASF.
³Commercially available from Exxon Chemicals America.

### Example 2

Charge 1 from Table 2 was blended with Charge 4 and half of Charge 5 until homogeneous. Charge 3 was then added under agitation. The mixture was heated to 120° F. and held for 15 minutes. Charge 2 was added slowly under agitation until well incorporated and free of lumps. The remainder of Charge 5 was added and mixed for one hour.

TABLE 2

| Charge # | Material | Amount (grams) |
|---|---|---|
| 1 | Binder of Example 1 | 75.77 |
| 2 | Zinc Dust SF7⁴ | 204.75 |
| 3 | M-P-A 4020 X⁵ | 3.50 |
| 4 | Ethyl Cellulose N-200⁶ | 2.72 |
| 5 | Solvent Blend | 77.00 |
| | 24% benzyl alcohol | |
| | 23% toluene | |
| | 24% MIBK | |
| | 24% SOLVESSO ® 100 | |
| | 5% n-butanol | |

⁴Zinc powder having an average particle size of 2.5 to 4.5 microns, commercially available from U.S. Zinc.
⁵Rheology additive commercially available from Elementis Specialties, Inc.
⁶Commercially available from Hercules Co.

### Example 3

Charge 1 from Table 3 was blended with Charge 2 and the mixture blended under agitation until the reaction was complete as evidenced by the mixture becoming clear. Charge 5 and half of Charge 6 were added and blended until homogeneous and Charge 5 was completely dissolved. Charge 3 was then added under agitation. The mixture was heated to 120° F. and held for 15 minutes. Charge 4 was added slowly under agitation until well incorporated and free of lumps. The remainder of Charge 5 was added and mixed for one hour.

TABLE 3

| Charge # | Material | Amount (grams) |
|---|---|---|
| 1 | Tyzor ® TOT⁷ | 57.00 |
| 2 | MACOL ® 98B | 3.00 |
| 3 | M-P-A 4020 X | 2.37 |
| 4 | Zinc Dust SF7 | 179.6 |
| 5 | Ethyl Cellulose N-200 | 2.43 |
| 6 | Solvent Blend | 84.00 |
| | 24% benzyl alcohol | |
| | 23% toluene | |
| | 24% MIBK | |
| | 24% SOLVESSO ® 100 | |
| | 5% n-butanol | |

⁷Tetra-2-ethylhexyl titanate commercially available from E.I. duPont de Nemours and Co.

### Example 4

Charge 1 from Table 4 was blended with Charge 2 and the mixture blended under agitation until the reaction was complete as evidenced by the mixture becoming clear. Charge 3 was added and stirred for 15 minutes. Charge 4 and then Charge 5 were added slowly under agitation until well incorporated and free of lumps. Charge 6 was then added and mixed for one hour.

TABLE 4

| Charge # | Material | Amount (grams) |
|---|---|---|
| 1 | Tyzor ® TOT | 57.00 |
| 2 | MACOL ® 98B | 3.00 |
| 3 | BYK ®-410⁸ | 1.86 |
| 4 | Zinc Dust SF7 | 170.60 |
| 5 | STAPA ® 4 ZnSn15⁹ | 10.00 |
| 6 | Solvent Blend | 30.00 |
| | 24% benzyl alcohol | |
| | 23% toluene | |
| | 24% MIBK | |
| | 24% SOLVESSO ® 100 | |
| | 5% n-butanol | |

⁸Rheological additive commercially available from BYK-Chemie.
⁹Zinc/tin alloy flake paste commercially available from Eckhart-Werke.

### Comparative Example C1

Charge 1 from Table 5 was blended with Charge 2 and the mixture blended under agitation until the reaction was complete as evidenced by the mixture becoming clear. Charge 5 and half of Charge 6 were added and blended until homogeneous and Charge 5 was completely dissolved. Charge 3 was then added under agitation. The mixture was heated to 120° F. and held for 15 minutes. Charge 4 was added slowly under agitation until well incorporated and free of lumps. The remainder of Charge 5 was added and mixed for one hour.

TABLE 5

| Charge # | Material | Amount (grams) |
|---|---|---|
| 1 | Tyzor ® TOT | 62.2 |
| 2 | MACOL ® 98B | 3.27 |
| 3 | M-P-A 4020 X | 2.00 |
| 4 | STAPA ® 4 ZnAl 7¹⁰ | 146.70 |
| 5 | Ethyl Cellulose N-200 | 2.00 |
| 6 | Solvent Blend | 69.00 |
| | 24% benzyl alcohol | |
| | 23% toluene | |
| | 24% MIBK | |
| | 24% SOLVESSO ® 100 | |
| | 5% n-butanol | |

¹⁰Zinc/Aluminum alloy flake paste commercially available from Eckhart-Werke.

### Examples 5-11

In Examples 5-11 of Table 6, the effect of organic modification or hybridization of titanate materials is demonstrated. For examples 5 through 11, the materials were blended by mechanical stirring at 25° C. until the reaction was complete as evidenced by a clear, homogeneous product. For examples 7 through 11, the mixtures were turbid and cloudy at first and became clear after approximately one hour of reaction time. All were fluid at room temperature.

TABLE 6

| | Example | | | | | | |
|---|---|---|---|---|---|---|---|
| | 5 | 6 | 7 | 8 | 9 | 10 | 11 |
| | (grams) | (grams) | (grams) | (grams) | (grams) | (grams) | (grams) |
| TYZOR ® TOT | 10.0 | — | — | — | — | — | 11.43 |
| TYZOR ® BTP¹¹ | — | 10.0 | 12.0 | 13.3 | 11.7 | 10.0 | — |
| MACOL ® 98B | — | — | 0.4 | 1.0 | 1.5 | 3.0 | — |
| TERATHANE ® | | | | | | | 0.4 |
| 1000¹² | | | | | | | |
| Solvent Blend of | 1.0 | 1.0 | 2.0 | 2.0 | 2.0 | 3.0 | 1.0 |
| Example 1 | | | | | | | |

¹¹n-butyl polytitanate commercially available from E.I. DuPont de Nemours and Co.
¹²Polytetramethylene ether glycol, commercially available from INVISTA.

### Application and Testing

The compositions of Examples 2, 3, 4, and C1 were applied to clean, sand blasted bolts by a dip spin method in a basket with a radius of 4 cm at a speed of 350 rpm for 15 seconds. The bolts were then baked at 200° C. for 20 minutes. In addition, the compositions were applied to clean cold rolled steel panels by drawdown bar method, and baked at 200° C. for 20 minutes. The resulting film thickness was approximately 8 microns. Subsequently, the coated bolts were topcoated by electrodeposition with Powercron 6100XP (black cationic Bisphenol A epoxy based electrocoat commercially available from PPG Industries, Inc.) for a total primer plus topcoat film thickness of approximately 16 microns, as measured using in accordance with ASTM B244 using a FISHERSCOPE® MMS thicknessmeter, as described above. Similarly, each primer coated steel panel was topcoated with electrocoat over half of its surface area. The electrocoat was cured by baking at 180° C. for 30 minutes.

The bolts were mounted on plastic panels and placed in a salt spray cabinet compliant with ASTM B117 standard. They were tested in sets of ten bolts for each example. The point of failure was defined as the number of hours of exposure required to generate the visible appearance of any red rust spots on more than two of the ten bolts in the set.

Adhesion testing was done by crosshatch as described above. Crosshatch was tested on primer only as well as primer plus electrocoated topcoat on the flat steel panels described above.

The products of examples 5 through 11 were applied to flat, clean cold rolled steel panels by conventional drawdown method then baked at 200° C. for 20 minutes. The resulting dry film thickness was approximately 4-5 microns. The resulting films were evaluated for film integrity visual inspection, thumbnail scratching, rubbing with an acetone soaked rag, and visual assessment of the extent of film cracking when examined by Scanning Electron Microscope (SEM) at 500× magnification.

Results are set forth in Tables 7 and 8.

TABLE 7

| | Example | | | |
|---|---|---|---|---|
| | 1 | 5 | 6 | 7 |
| Appearance | Smooth, dull | powdery, rough | powdery, | slightly powdery, |
| | | | rough | very cloudy |
| Thumbnail | no scratch | very easy | very easy | easy |
| Scratch | | | | |
| Acetone soaked | 100 rubs had no | rubbed off easily | rubbed off easily | 5 rubs through to |
| rag rub | effect | | | metal |
| 500x (SEM) | no cracks, | powdery, no | powdery, no | mud cracks with |
| cracking | continuous film | continuous film | continuous film | large gaps and |
| appearance | | | | flaking |
| 500X | | | | |
| Crosshatch | no loss (100% | complete loss | complete loss | no loss (100% |
| Adhesion | adhesion) | | | adhesion) |

| | Example | | | |
|---|---|---|---|---|
| | 8 | 9 | 10 | 11 |
| Appearance | smooth, | smooth, clear | smooth, clear | smooth, dull |
| | slightly cloudy | | | |
| Thumbnail Scratch | easy | Difficult | no scratch | difficult |
| Acetone soaked rag | 100 rubs has | 100 rubs has no | 100 rubs has no | 100 rubs has no |
| rub | no effect | effect | effect | effect |
| 500x (SEM) | more | less cracking, | Very little | very similar to 8 |
| cracking | continuous, | very narrow | cracking, narrow | |
| appearance | less cracking | gaps, no flaking | gaps, mostly | |
| 500X | with narrower | (vs 8) | continuous, no | |
| | gaps, no | | flaking (vs 9) | |
| | flaking (vs 7) | | | |
| Crosshatch | no loss (100% | no loss (100% | no loss (100% | no loss (100% |
| Adhesion | adhesion) | adhesion) | adhesion) | adhesion) |

TABLE 8

| | Example | | | |
|---|---|---|---|---|
| | 2 | 3 | 4 | C1 |
| Salt Spray | 500 | 500 | 700 | 50 |
| (Hours) | | | | |
| Crosshatch Adhesion | no loss | no loss | no loss | complete |
| Primer only | | | | loss |
| Crosshatch Adhesion | no loss | no loss | no loss | complete |
| Primer plus Electrocoat | | | | loss |

### Examples 12-14

In Examples 12-14 of Table 9, the effect of modification or hybridization of titanate materials with a silicon-based polymer is demonstrated. For examples 13 and 14, the mixtures required approximately 8 hours to react and become clear. All were fluid at room temperature.

TABLE 9

| | Example | | |
|---|---|---|---|
| | 12 (grams) | 13 (grams) | 14 (grams) |
| TYZOR ® TOT | 10.0 | 10.0 | 10.0 |
| Dow Corning ® 840 Resin¹³ | — | 1.0 | — |
| SILIKOFTAL ® HTT¹⁴ | — | — | 0.6 |
| Solvent Blend of Example 1 | 1.0 | 1.0 | 1.0 |

¹³Silanol functional silicone resin available from Dow Corning.
¹⁴Polyester silicone resin available from Degussa.

The products of examples 12 through 14 were applied to flat, clean cold rolled steel panels by conventional drawdown method then baked at 200° C. for 20 minutes. The resulting dry film thickness was approximately 4-5 microns. The resulting films were evaluated for film integrity visual inspection, thumbnail scratching, rubbing with an acetone soaked rag, and visual assessment of the extent of film cracking when examined by Scanning Electron Microscope (SEM) at 500× magnification. Results are set forth in Table 10.

TABLE 10

| | Example | | |
|---|---|---|---|
| | 12 | 13 | 14 |
| Appearance | brown, rough, | Clear, smooth | Clear, smooth |
| | powdery | | |
| Thumbnail | very easy | difficult | difficult |
| Scratch | | | |
| Acetone soaked | through in 30 | 100 rubs | 100 rubs |
| rag rub | rubs | no effect | no effect |
| 500x (SEM) | severe mud | less mud cracking | more continuous, |
| cracking | cracking, large | and small gaps | less cracking |
| appearance | gaps and some | versus 12 | versus 13 |
| 500X | flaking | | |
| Crosshatch | no loss (100% | no loss (100% | no loss (100% |
| Adhesion | adhesion) | adhesion) | adhesion) |

It will be appreciated by those skilled in the art that changes could be made to the embodiments described above without departing from the broad inventive concept thereof. It is understood, therefore, that this invention is not limited to the particular embodiments disclosed, but it is intended to cover modifications which are within the spirit and scope of the invention, as defined by the appended claims.

1. A metal article at least partially coated with a multi-component composite coating comprising:
(a) a zinc-rich primer coating; and
(b) an electrodeposited coating deposited over at least a portion of the zinc-rich primer coating,
wherein the article is resistant to corrosion after 500 hours of exposure when the zinc-rich primer coating has a dry film thickness of less than 0.5 mils and the total combined dry film thickness of the zinc-rich primer and the electrodeposited coating is 1.5 mils or less.

2. The article of claim 1, wherein the zinc-rich primer coating is deposited from a composition comprising zinc powder.

3. The article of claim 2, wherein the zinc powder is present in an amount of at least 25 percent by weight, based on the total weight of the zinc particles.

4. The article of claim 1, wherein the zinc-rich primer coating is deposited from a composition comprising zinc/tin alloy particles.

5. The article of claim 1, wherein the zinc-rich primer coating is deposited from a composition comprising a binder formed from titanate and/or a partial hydrolysate thereof.

6. The article of claim 5, wherein the binder comprises a hybrid organic-inorganic copolymer formed from:
(1) a titanate and/or a partial hydrolysate thereof, and
(2) a polyfunctional polymer having functional groups reactive with alkoxy groups of the titanate and/or the partial hydrolysate thereof.

7. The article of claim 6, wherein the polyfunctional polymer comprises a polyol.

8. The article of claim 6, wherein the polyfunctional polymer is an acrylic polymer, a polyester polymer, a polyurethane polymer, a polyether polymer, a silicon-based polymer, or mixture thereof.

9. The article of claim 7, wherein the polyol is formed from reactants comprising (i) a polyol comprising an aromatic group and (ii) an alkylene oxide.

10. The article of claim 5, wherein the titanate comprises a chelated titanate.

11. The article of claim 5, wherein the binder is present in the composition in an amount of 2 to 10 percent by weight, based on the total weight of solids in the composition.

12. The article of claim 1, wherein the article is a small part.

13. The article of claim 1, wherein the total combined dry film thickness of the zinc-rich primer and the electrodeposited coating is 1 mil or less.

14. The article of claim 1, wherein the electrodeposited coating is deposited directly over at least a portion of the zinc-rich primer.

15. The article of claim 1, wherein the article is resistant to corrosion after 1000 hours of exposure when the total combined dry film thickness of the zinc-rich primer and the electrodeposited coating is 1.5 mils or less.

16-20. (canceled)
